(19) United States
(12) Patent Application Publication
(10) Pub. No.: US 2023/0415394 A1
(43) Pub. Date: Dec. 28, 2023

(54) CONTROL DEVICE AND CONTROL METHOD

(71) Applicant: FANUC CORPORATION, Yamanashi (JP)

(72) Inventor: Atsushi HORIUCHI, Yamanashi-ken (JP)

(21) Appl. No.: 18/252,241

(22) PCT Filed: Nov. 10, 2021
(86) PCT No.: PCT/JP2021/041261

§ 371 Date: May 9, 2023

(30) Foreign Application Priority Data
Nov. 16, 2020 (JP) 2020-190287

(51) Int. Cl. B29C 45/77

(52) U.S. Cl. CPC B29C 45/77; B29C 2945/7612; B29C 2945/76605; B29C 2945/76006; B29C 2945/76187; B29C 2945/76367; B29C 2945/76381; B29C 2945/76498

(57) ABSTRACT

A control device which is for an injection molding machine and which includes a suck-back control unit that causes a screw which has reached a prescribed measurement position to be sucked back at a prescribed suck-back velocity; a reverse rotation control unit that causes the screw to be reversely rotated on the basis of a prescribed reverse rotation condition value at and after the initiation of the suck-back; a measurement unit that measures a reverse rotation state value of the screw; and a suck-back completion control unit that causes the suck-back to be completed when the reverse rotation state value has reached a threshold value.

### TECHNICAL FIELD

The present invention relates to a control device and a control method for controlling an injection molding machine.

### BACKGROUND ART

In a molding cycle of an injection molding machine, a process (pressure reducing process) is included of causing the pressure of a metered molten resin to be reduced to a predetermined target pressure. In JP H01-148526 A, it is disclosed that, in relation to the pressure reducing process, by monitoring the pressure of a resin, sucking back is caused to end in the case that the pressure of the resin has fallen to a constant value.

### SUMMARY OF THE INVENTION

Such an injection molding machine includes a cylinder and a screw. The screw is capable of being sucked back (moved rearward) within the cylinder. The pressure of the resin inside the cylinder rapidly decreases in accordance with the sucking back of the screw being carried out. However, the pressure of the resin fluctuates under the influence of a viscous resistance of the resin, a load applied to the screw, or the like. Accordingly, in JP H01-148526 A, a problem arises in that the timing at which sucking back ends experiences variations in each of the molding cycles.

Thus, the present invention has the object of reducing the variation in the timing at which sucking back ends.

A first aspect of the present invention is characterized by a control device for an injection molding machine, the injection molding machine including a cylinder and a screw configured to rotate and move forward and rearward within the cylinder, the control device being configured to perform a metering of resin inside the cylinder by moving the screw rearward to a predetermined metering position while the screw is being forwardly rotated, the control device including a suck-back control unit configured to suck back the screw at a predetermined suck-back speed after the screw has reached the predetermined metering position, a reverse rotation control unit configured to perform reverse rotation of the screw based on a predetermined reverse rotation condition value after sucking back of the screw has started, a measurement unit configured to measure a reverse rotation state value indicating a reverse rotation state of the screw from a time when the reverse rotation of the screw has been started, and a suck-back ending control unit configured to cause the sucking back of the screw by the suck-back control unit to end, at a time when the reverse rotation state value has reached a threshold value.

A second aspect of the present invention is characterized by a control method for an injection molding machine, the injection molding machine including a cylinder and a screw configured to rotate and move forward and rearward within the cylinder, the control method for performing a metering of resin inside the cylinder by moving the screw rearward to a predetermined metering position while the screw is being forwardly rotated, the control method including a suck-back control step of sucking back the screw at a predetermined suck-back speed after the screw has reached the predetermined metering position, a reverse rotation control step of performing reverse rotation of the screw based on a predetermined reverse rotation condition value after sucking back of the screw has started, a measurement step of measuring a reverse rotation state value indicating a reverse rotation state of the screw from a time when the reverse rotation of the screw has been started, and a suck-back ending step of causing the sucking back of the screw by the suck-back control step to end, at a time when the reverse rotation state value has reached a threshold value.

According to the aspects of the present invention, a variation in the timing at which sucking back ends is reduced.

### BRIEF DESCRIPTION OF DRAWINGS

FIG. 1 is a side view of an injection molding machine according to an embodiment;

FIG. 2 is a schematic configuration diagram of an injection unit;

FIG. 3 is a schematic configuration diagram of a control device;

FIG. 4 is a first flowchart illustrating a process flow of a control method according to the embodiment;

FIG. 5 is a first time chart illustrating a timewise transition of a rearward movement speed of a screw, a rotational speed of the screw, and a pressure of a resin in the case that the control method shown in FIG. 4 is executed;

FIG. 6 is a second flowchart illustrating a process flow of a control method according to the embodiment;

FIG. 7 is a second time chart illustrating a timewise transition of a rearward movement speed of a screw, a rotational speed of the screw, and a pressure of the resin in the case that the control method shown in FIG. 6 is executed;

FIG. 8 is a schematic configuration diagram of a control device according to Exemplary Modification 2;

FIG. 9 is an exemplary configuration of a table that is stored in a storage unit according to Exemplary Modification 2;

FIG. 10 is a schematic configuration diagram of a control device according to Exemplary Modification 3; and

FIG. 11 is a schematic configuration diagram of a control device according to Exemplary Modification 5.

### DETAILED DESCRIPTION OF THE INVENTION

A control device and a control method according to the present invention will be presented and described in detail below in relation to preferred embodiments thereof with reference to the accompanying drawings.

### EMBODIMENTS

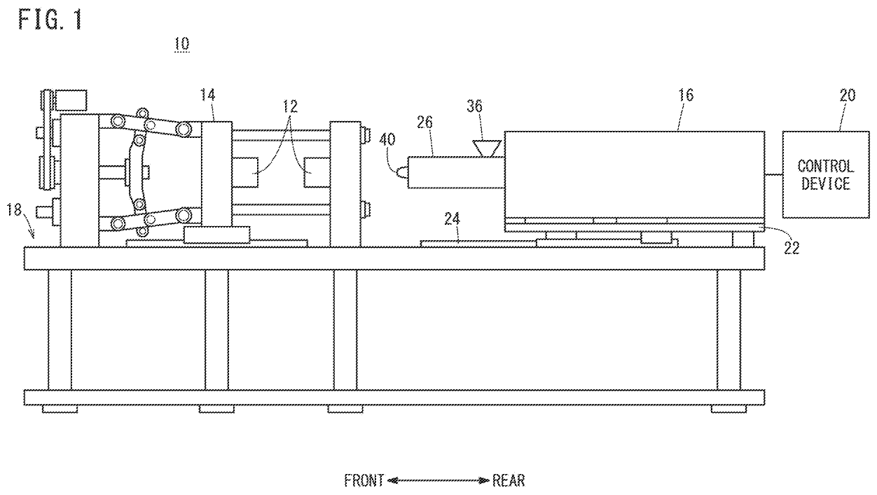

FIG. 1 is a side view of an injection molding machine 10 according to an embodiment of the present invention.

The injection molding machine 10 comprises a mold clamping unit 14, an injection unit 16, a machine base 18, and a control device 20. The mold clamping unit 14 includes a mold 12 that is capable of being opened and closed. The injection unit 16 is disposed rearward of the mold clamping unit 14 (refer to FIG. 1). The machine base 18 serves to support the mold clamping unit 14 and the injection unit 16. The mold clamping unit 14 and the machine base 18 may be configured based on a known technique.

Initially, hereinafter, the injection unit 16 will be described. The injection unit 16 is a control target of the control device 20.

The injection unit 16 is supported on a base 22. The base 22 is supported by a guide rail 24 so as to be capable of moving forward and rearward. Moreover, the guide rail 24 is installed on the machine base 18. Consequently, the injection unit 16 becomes capable of moving forward and rearward on the machine base 18.

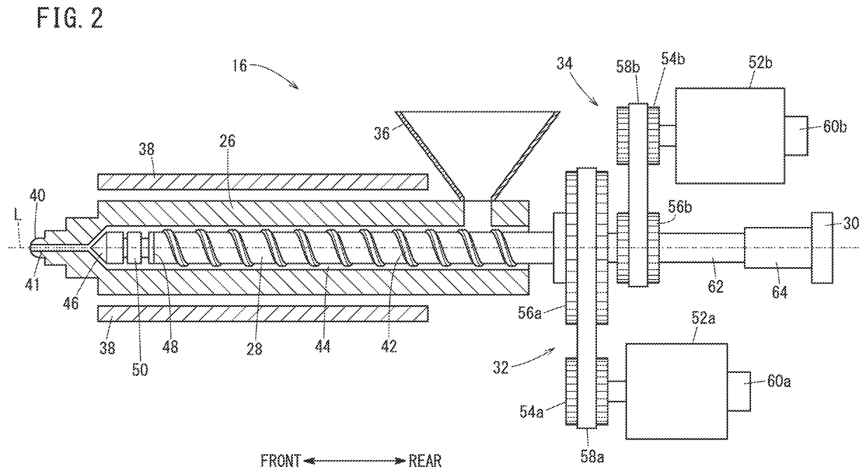

FIG. 2 is a schematic configuration diagram of the injection unit 16.

The injection unit 16 is equipped with a cylinder (heating cylinder) 26, a screw 28, a pressure sensor 30, a first drive device 32, and a second drive device 34. The cylinder 26 is a tubular member. The screw 28 is installed inside the cylinder 26. The pressure sensor 30 is arranged on the screw 28. The first drive device 32 and the second drive device 34 are connected to the screw 28.

An imaginary line L in FIG. 2 indicates an axial line of the cylinder 26. The imaginary line L extends parallel to a front-rear direction. Moreover, it should be noted that the imaginary line L also serves as the axial line of the screw 28. A system in which the axial line of the cylinder 26 and the axial line of the screw 28 overlap (i.e., become the same imaginary line L) is also called an “in-line (in-line screw) system”. Further, the injection molding machine to which the in-line system is applied is also referred to as an “in-line injection molding machine”.

The structure of the injection unit 16 of such an in-line injection molding machine is simpler than other types of injection molding machines. Accordingly, the injection unit 16 is superior in terms of its maintainability than other types of injection molding machines. Moreover, another type of the injection molding machine, for example, is a preplasticating type of injection molding machine.

The cylinder 26 is equipped with a hopper 36, a heater 38, and a nozzle 40 (refer to FIG. 2). The hopper 36 is installed in close proximity to a rearward end part of the cylinder 26. The hopper 36 is provided with a supply port for the purpose of supplying a resin, which is a molding material, to the cylinder 26. The resin supplied to this supply port, for example, is in the form of pellets. The heater 38 serves to heat the cylinder 26. The nozzle 40 is installed on a forward-side distal end of the cylinder 26. The nozzle 40 includes an injection port 41. The injection port 41 places the interior and the exterior of the cylinder 26 in communication.

The screw 28 includes a flight portion 42. The flight portion 42 is provided in a single helical shape that extends in the front-rear direction. The flight portion 42 and the inner wall of the cylinder 26 form a flow path 44. The flow path 44 has a single helical shape. The resin inside the cylinder 26 is guided forward along the flow path 44 in accordance with the forward rotation of the screw 28.

The screw 28 which includes the single helical flight portion 42 is classified into a type also referred to as a “single flight type”. However, the type of the screw 28 is not limited to being a single flight type. For example, the type of the screw 28 may be a “double flight type” of screw. In the case that the type of the screw 28 is a double flight type, the flight portion 42 is provided in the shape of a double helix.

The screw 28 includes a screw head 46, a check seat 48, and a check ring (a backflow prevention ring) 50. The screw head 46 is a distal end part in the frontward direction of the screw 28. The check seat 48 is disposed rearward of the screw head 46 at a distance therebetween. Between the screw head 46 and the check seat 48, the check ring 50 is cable of moving relatively in the front-rear direction with respect to the check seat 48.

The check ring 50 opens or closes the flow path 44 by moving relative to the check seat 48. For example, during a later-described metering, the check ring 50 receives a forwardly directed pressure from the resin that exists on the rear side of the check ring 50. The check ring 50 receives the forwardly directed pressure, and thereby moves in a forward direction with respect to the check seat 48. In this case, the check ring 50 gradually opens the flow path 44. As a result, the resin existing on the rearward side of the check ring 50 becomes capable of flowing forward beyond the check seat 48 along the flow path 44.

Further, for example, during a later-described injection, the check ring 50 receives a rearwardly directed pressure from the resin that exists on the forward side of the check ring 50. The check ring 50 receives the rearwardly directed pressure, and thereby moves in a rearward direction with respect to the check seat 48. In this case, the check ring 50 gradually closes the flow path 44. As a result, the resin existing on the forward side of the check ring 50 is prevented from flowing rearward (backflowing) beyond the check seat 48 along the flow path 44. In particular, the back flowing of the resin is maximally suppressed in the case that the check ring 50 and the check seat 48 are in contact with each other.

The pressure sensor 30, for example, is a load cell. The pressure sensor 30 is attached, for example, to a rear end part of the screw 28. The screw 28 receives a pressure (a pressure of the resin) P from the resin that flows along the flow path 44. The pressure sensor 30 outputs a detection signal corresponding to the pressure P of the resin. The detection signal is input to the control device 20.

The first drive device 32 is a device that causes the screw 28 to be rotated within the cylinder 26. The first drive device 32 comprises a servomotor 52a, a drive pulley 54a, a driven pulley 56a, and a belt member 58a. The servomotor 52a is equipped with a rotating shaft. The drive pulley 54a rotates integrally with the shaft of the servomotor 52a. The driven pulley 56a is disposed integrally on the screw 28. The belt member 58a transmits the rotational force of the shaft of the servomotor 52a from the drive pulley 54a to the driven pulley 56a.

The shaft of the servomotor 52a transmits the rotational force to the screw 28 via the drive pulley 54a, the belt member 58a, and the driven pulley 56a. The screw 28 rotates in accordance with the transmitted rotational force. Moreover, in accordance with a change in the direction of rotation of the shaft of the servomotor 52a, the direction of rotation of the screw 28 can be switched between the forward rotation and the reverse rotation.

A position/speed sensor 60a is provided on the servomotor 52a. The position/speed sensor 60a outputs a detection signal corresponding to the rotational position of the shaft of the servomotor 52a. The detection signal is input to the control device 20. Consequently, based on the detection signal of the position/speed sensor 60a, the control device 20 is capable of acquiring the amount of rotation and the rotational speed of the screw 28. The control device 20 may also acquire a rotational acceleration of the screw 28 based on the detection signal of the position/speed sensor 60a.

The second drive device 34 is a device that causes the screw 28 to move forward and rearward within the cylinder 26. Moreover, in the present embodiment, it should be noted that, unless otherwise specified, the forward movement (advancing) and rearward movement (retracting) of the screw 28 refers to the relative movement of the screw 28 along the front-rear direction with respect to the cylinder 26.

The second drive device 34 comprises a servomotor 52b, a drive pulley 54b, a driven pulley 56b, a belt member 58b, a ball screw 62, and a nut 64. The servomotor 52b is equipped with a rotating shaft. The drive pulley 54b rotates integrally with the shaft of the servomotor 52b. The belt member 58b transmits the rotational force of the shaft of the servomotor 52b from the drive pulley 54b to the driven pulley 56b. The driven pulley 56b is connected to the ball screw 62. The ball screw 62 is screwed-engaged with the nut 64. The ball screw 62 is installed in parallel with the advancing and retracting direction (front-rear direction) of the screw 28. The axis of the ball screw 62 overlaps with the imaginary line L. The ball screw 62 is connected to the screw 28.

The shaft of the servomotor 52b transmits the rotational force to the ball screw 62 via the drive pulley 54b, the belt member 58b, and the driven pulley 56b. The ball screw 62 rotates in accordance with the transmitted rotational force. The nut 64 moves forward and rearward corresponding to the rotation of the ball screw 62. Consequently, the screw 28 moves linearly along the front-rear direction. Moreover, the advancing and retracting of the screw 28 is capable of being changed in accordance with a change in the direction of rotation of the shaft of the servomotor 52b.

The servomotor 52b is provided with a position/speed sensor 60b. The position/speed sensor 60b outputs a detection signal corresponding to the rotational position of the shaft of the servomotor 52b. The position/speed sensor 60b, for example, is the same sensor as the position/speed sensor 60a. A detection signal from the position/speed sensor 60b is input to the control device 20. Consequently, based on the detection signal of the position/speed sensor 60b, the control device 20 is capable of calculating a rearward movement distance of the screw 28, and a rearward movement speed of the screw 28.

Taking into account the injection unit 16 described above, the processes executed by the injection molding machine 10 in order to obtain a molded product will be described below. Moreover, in the following description, within the interior of the cylinder 26, a region on the forward side of the check seat 48 is also referred to as a “metering region”.

The screw 28 of the injection unit 16 is rotated forward based on a predetermined rotational speed (metering speed) V_{rf}. Consequently, the resin supplied to the cylinder 26 from the supply port of the hopper 36 is fed and compressed forward along the flow path 44. During feeding and compressing of the resin, the resin is melted (plasticized) due to being heated by the heater 38, and by the rotating force of the screw 28. By the molten resin being fed and compressed in the forward direction by the forward rotation of the screw 28, the resin reaches the metering region. The molten resin is accumulated and stored in the metering region.

Feeding and compressing of the resin to the metering region is started from a state in which the screw 28 has been fully advanced within the cylinder 26. More specifically, feeding and compressing of the resin to the metering region is started from a state in which the volume of the metering region is at a minimum. As the amount of the resin inside the metering region increases, the pressure P of the resin increases. In this instance, the screw 28 is moved rearward in order to cause the pressure P of the resin to be reduced. In other words, when the screw 28 is moved rearward, the metering region is expanded. Consequently, the pressure P of the resin decreases. Moreover, the screw 28 continues to undergo forward rotation (feeding and compressing of the resin) even after the rearward movement thereof is started. Further, the control device 20 also controls the rearward movement speed of the screw 28. Consequently, during the rearward movement of the screw 28, the pressure P of the resin is maintained at a predetermined value (metering pressure) P₁.

The feeding and compressing of the resin is carried out until the screw 28 that is being retracted reaches a predetermined position (metering position).

The process of feeding and compressing the resin until the screw 28 reaches the metering position is referred to as a “metering process” or simply “metering”. By performing such metering, the injection unit 16 is capable of accumulating and storing a certain predetermined amount of the resin in the metering region.

The injection unit 16 performs the metering based on the metering speed V_{rf} and the metering pressure P₁. The operator may appropriately set the metering speed V_{rf} and the metering pressure P₁ that were investigated by the operator him/herself. However, the metering pressure P₁ is greater than atmospheric pressure.

After the screw 28 has reached the metering position, the injection unit 16 causes the pressure P of the resin to be reduced from the metering pressure P₁ to a target pressure P₀. The process of causing the pressure P of the resin to be reduced from the metering pressure P₁ to the target pressure P₀ is referred to as a “pressure reducing process” or simply “pressure reducing”. When the pressure P of the resin is reduced, the momentum of the resin so as to make the resin flow in the forward direction weakens. The injection unit 16, by carrying out the reduction in pressure after the metering, suppresses the flowing of the resin in the metering region to the injection port 41. Consequently, the occurrence of drooling or cold slug is suppressed.

According to the present embodiment, the target pressure P₀ is the atmospheric pressure (the value detected by the pressure sensor 30=zero). However, the target pressure P₀ may be set to a pressure other than atmospheric pressure, as long as the target pressure P₀ lies within a range less than the metering pressure P₁.

In order to cause the pressure P of the resin to be reduced in the pressure reducing process, the injection unit 16 of the present embodiment sucks back or reversely rotates the screw 28. By being sucked back in the pressure reducing process, the screw 28 is moved further rearward from the metering position. In this instance, the volume of the metering region expands in accordance with the distance by which the screw 28 is moved rearward. Consequently, the volume of the resin in the metering region is expanded. Further, the density of the resin in the metering region is reduced. As a result, the pressure P of the resin decreases.

During suck-back, the screw 28 is moved rearward at a predetermined speed. Hereinafter, the predetermined speed is also referred to as a suck-back speed V_{sb}. The suck-back speed V_{sb} is set in the control device 20. The operator may set the suck-back speed V_{sb} that was determined through consideration by him/herself, in the control device 20. However, the operator may also set, in the control device 20, a default value for the suck-back speed V_{sb} which is specified by the manufacturer of the injection molding machine 10.

The direction of reverse rotation of the screw 28 is opposite to the direction of rotation (direction of forward rotation) during metering. When the screw 28 is rotated in reverse, in the interior of the cylinder 26, the resin flows in reverse (backflows). Consequently, the resin is scraped out in a more rearward direction than the cylinder 26, and the density of the entirety of the resin inside the cylinder 26 decreases. As a result, the pressure P of the resin decreases.

The screw 28 according to the present embodiment undergoes reverse rotation based on a reverse rotation condition value CV_{rb}. The reverse rotation condition value CV_{rb} is information including at least two from among a target reverse rotational speed V_{rb}, a continued time period of reverse rotation T_{rb}, and a target amount of reverse rotation R_{rb}. The target reverse rotational speed V_{rb} is a target value of the rotational speed of the screw 28 during reverse rotation thereof. The reverse rotational speed of the screw 28 is controlled with the target reverse rotational speed V_{rb} acting as a target. The continued time period of reverse rotation T r b is a target value for the length of time during which the reverse rotation is to be continued. The target amount of reverse rotation R_{rb} is a target value of the amount of rotation (angle of rotation) in the reverse direction of rotation of the screw 28.

The operator may select which ones of the target reverse rotational speed V_{rb}, the continued time period of reverse rotation T_{rb}, and the target amount of reverse rotation R_{rb} are to be included in the reverse rotation condition value CV_{rb}. The operator may investigate at least one from among the values included in the reverse rotation condition value CV_{rb}, and set the value in the control device 20. The operator may use a default value as preset by the manufacturer of the injection molding machine 10, in relation to at least one of the values from among the plurality of values included in the reverse rotation condition value CV_{rb}. For example, the reverse rotation condition value CV_{rb} may include a target reverse rotational speed V_{rb} that was investigated by the operator, and a continued time period of reverse rotation T_{rb} that is a default value.

When two values from among the target reverse rotational speed V_{rb}, the continued time period of reverse rotation T_{rb}, and the target amount of reverse rotation R_{rb} are determined, the remaining one of such values is naturally determined on its own accord. For example, when the target reverse rotational speed V_{rb} and the continued time period of reverse rotation T r b are determined, the target amount of reverse rotation R_{rb} is naturally determined as a result of multiplying the target reverse rotational speed V_{rb} and the continued time period of reverse rotation T_{rb}.

At a time after the pressure reducing process, the injection unit 16 causes the screw 28 to move forward. Consequently, the resin inside the metering region is pushed out of the cylinder 26 (i.e., into the mold 12) via the injection port 41. Such a process is referred to as an “injection process” or simply “injection”. The injection unit 16 fills the mold 12 with the resin by performing the injection. Moreover, it should be noted that the mold 12 is in a closed state during the period when injection is being performed. The mold clamping unit 14 applies a mold clamping force to the mold 12 that is in the closed state.

The resin that is filled in the mold 12 is solidified by cooling. Such a process is referred to as a “cooling process” or simply “cooling”. When the resin inside the mold 12 solidifies, the mold clamping unit 14 opens the mold 12. The process of opening the mold 12 may also be referred to as a “mold opening process” or simply “mold opening”. The solidified resin (the molded product) can be taken out from the opened mold 12. The process of taking out the molded product from the mold 12 may also be referred to as a “removal process” or simply “removal”. The mold clamping unit 14 places the mold 12 in a closed state again after the molded product has been taken out. Further, the process of closing the mold 12 may also be referred to as a “mold closing process” or simply “mold closing”.

The plurality of processes (metering, pressure reducing, injection, cooling, mold opening, removal, and mold closing) described above are performed in a routine manner as a “molding cycle”. By repeatedly carrying out the molding cycle, the injection molding machine 10 is capable of mass producing the molded products. The time required to complete one molding cycle may also be referred to as a “cycle time”.

Hereinafter, the pressure reducing process will be further described. In the pressure reducing process, the screw 28 executes sucking back or reverse rotation. In this instance, when the screw 28 is sucked back, the volume of the metering region rapidly expands. In this case, the pressure P of the resin rapidly decreases. On the other hand, when the screw 28 is rotated in reverse, the resin gently flows backward. In this case, the pressure P of the resin gently decreases. In other words, causing the screw 28 to be sucked back is capable of causing the pressure P of the resin to be reduced more rapidly than causing the screw 28 to be rotated in reverse.

However, in the case that the suck-back ending condition at which sucking back is ended is that the pressure P of the resin reaches the target pressure P₀, a problem arises in that the end timing at which sucking back is ended varies for each of the molding cycles. In other words, the pressure P of the resin fluctuates in accordance with the viscous resistance of the resin that is melted inside the cylinder 26, and the galling load of the screw 28. It is practically impossible to have this variation to be made constant over a plurality of molding cycles. The reason therefor is because the resin acquires fluidity. Due to the aforementioned reason, in the case that sucking back is executed with the end condition being that the pressure P of the resin reaches the target pressure P₀, the end timing at which sucking back is ended is not constant. In the case that the timing at which sucking back is ended is not constant, the cycle time in mass producing the molded products varies.

Further, sucking back has a problem in that, in comparison with the reverse rotation, the amount of the resin that is excessively metered in the metering process cannot be adjusted. That is, during forward rotation, the screw 28 receives an influence due to the inertia associated with the rotational driving of the screw 28, and the viscous resistance of the resin. Consequently, a time lag occurs between a point in time when the screw 28 reaches the metering position, and a point in time when the forward rotation of the screw 28 comes to a stop. In other words, the screw 28 continues being forwardly rotated for a short time period even after having reached the metering position. As a result, after the screw 28 has reached the metering position, an excessive amount of resin is fed and compressed into the metering region. Such a phenomenon is also referred to as overrun because the forward rotation of the screw 28 continues without being stopped at the point in time when the screw 28 has reached the metering position. From the point of view of the operator, it is preferable to keep the amount of the resin in the metering region at an appropriate amount by preventing overrun from occurring. However, the fact that the screw 28 is influenced by the inertia and the viscous resistance of the resin is a physical phenomenon that cannot be practically avoided. Accordingly, it is practically difficult to completely prevent overrun from occurring. Thus, instead of preventing overrun from occurring, it is considered to bring the amount of the resin closer to the appropriate amount, by causing any excess resin to be made to flow back from the interior of the metering region to the exterior of the metering region. In this respect, such sucking back is an operation of causing the volume of the metering region to expand, and is not an operation to promote the resin to flow in reverse from the interior of the metering region to the exterior of the metering region. Accordingly, it is difficult to reduce the excessive resin inside the metering region by performing sucking back of the screw 28.

On the other hand, the reverse rotation of the screw 28 causes the resin to flow in reverse from the interior of the metering region to the exterior of the metering region. Consequently, the amount of the resin inside the metering region can be made to approach the appropriate amount.

However, the reverse rotation of the screw 28 must be performed more slowly than the forward rotation in the metering process, so that the screw 28 is not damaged upon receiving the influence of the rotational load. Accordingly, the vigor with which the pressure P of the resin is reduced during the reverse rotation is moderate in comparison with the case in which the screw 28 is sucked back. Due to such a reason, in relation to the point of causing the pressure P of the resin to be rapidly reduced, causing the screw 28 to be sucked back is preferable to causing the screw 28 to be rotated in reverse.

The control device 20 according to the present embodiment will be described while taking into account the above description.

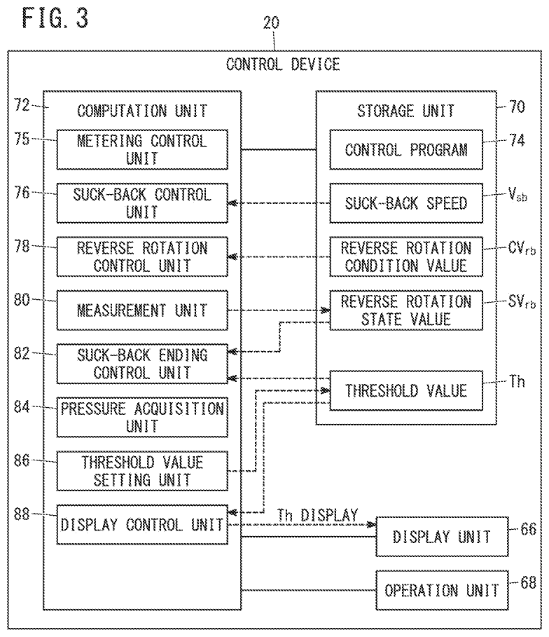

FIG. 3 is a schematic configuration diagram of the control device 20.

The control device 20 is an electronic device (a computer) that controls at least the injection unit 16 of the injection molding machine 10. According to the present embodiment, the control device 20 controls the injection unit 16 based on a CNC (Computerized Numerical Control) method. The control device 20 is equipped with a display unit 66, an operation unit 68, a storage unit 70, and a computation unit 72.

The display unit 66 serves to display information. The display unit 66, for example, is a display device. The display unit 66 is equipped with a display screen. Such a display screen contains a liquid crystal or an OEL (Organic Electro-Luminescence) as a material thereof. The display screen of the display unit 66 displays, for example, a reverse rotation condition value CV_{rb} or a reverse rotation state value SV_{rb} (to be described later) of the screw 28.

The operation unit 68 receives information (instructions) that are input to the control device 20. For example, the operator inputs the suck-back speed V_{sb} and the reverse rotation condition value CV_{rb} to the control device 20 via the operation unit 68. The operation unit 68 includes, for example, a keyboard, a mouse, and a touch panel. The touch panel is installed on the display unit 66, for example.

The storage unit 70 serves to store information. The storage unit 70 includes a memory. For example, the storage unit 70 includes a RAM (Random Access Memory) and a ROM (Read Only Memory). A control program 74 is stored in the storage unit 70. The control program 74 is a program in order to cause the control device 20 to execute the control method (the control method for the injection molding machine 10) according to the present embodiment. Further, the storage unit 70 stores a threshold value Th, the suck-back speed V_{sb}, and the reverse rotation condition value CV_{rb}. The threshold value Th will be described later. The storage unit 70 may store information other than the control program 74, the threshold value Th, the suck-back speed V_{sb}, and the reverse rotation condition value CV_{rb}.

The computation unit 72 processes information by performing calculations. The computation unit 72 includes a processor. For example, the computation unit 72 includes a CPU (Central Processing Unit), and a GPU (Graphics Processing Unit). The computation unit 72 is equipped with a metering control unit 75, a suck-back control unit 76, a reverse rotation control unit 78, a measurement unit 80, a suck-back ending control unit 82, a pressure acquisition unit 84, a threshold value setting unit 86, and a display control unit 88 (refer to FIG. 3). The metering control unit 75, the suck-back control unit 76, the reverse rotation control unit 78, the measurement unit 80, the suck-back ending control unit 82, the pressure acquisition unit 84, the threshold value setting unit 86, and the display control unit 88 are virtually realized by the computation unit 72 executing the control program 74.

The metering control unit 75 controls the injection unit 16 in relation to the metering process. More specifically, in the metering process, the metering control unit 75 drives the servomotor 52a. Consequently, in the metering process, the metering control unit 75 causes the screw 28 to rotate forward at the predetermined rotational speed (metering speed V_{rf}) V_{rf}. Further, in the metering process, the metering control unit 75 controls the rearward movement speed of the screw 28 by driving the servomotor 52b. Consequently, the pressure P of the resin is adjusted to the predetermined metering pressure P₁. In this instance, the metering speed V_{rf} and the metering pressure P₁ are stored in the storage unit 70. However, illustration of the metering speed V_{rf} and the metering pressure P₁ is omitted. Further, the pressure P of the resin is capable of being acquired from the pressure acquisition unit 84, which will be described later.

After completion of the metering, by driving the servomotor 52b, the suck-back control unit 76 causes the screw 28 to be sucked back. Consequently, the suck-back control unit 76 is capable of reducing the pressure P of the resin. In this instance, the suck-back control unit 76 causes the screw 28 to be sucked back at the predetermined suck-back speed V_{sb}. More specifically, after the screw 28 has reached the predetermined metering position, the suck-back control unit 76 causes the screw 28 to be sucked back at the suck-back speed that is stored in the storage unit 70.

At a time after sucking back of the screw 28 has started, the reverse rotation control unit 78 causes the screw 28 to rotate in reverse based on the predetermined reverse rotation condition value CV_{rb}. Consequently, the reverse rotation control unit 78 is capable of reducing the pressure P of the resin. In the case of the present embodiment, the reverse rotation control unit 78 can cause the screw 28 to rotate in reverse by driving the servomotor 52a. The reverse rotation control unit 78 may initiate the reverse rotation of the screw 28 at the same time that sucking back is started. The reverse rotation control unit 78 causes the screw 28 to rotate in reverse based on the predetermined reverse rotation condition value CV_{rb}. In order to cause such a situation to be realized, the reverse rotation control unit 78 may control the screw 28 while monitoring the rotational speed of the screw 28 and the time length for which rotation of the screw is conducted. Moreover, it should be noted that the rotational speed and the time length for which rotation of the screw 28 is conducted are measured by the measurement unit 80 (to be described later).

It is preferable for the predetermined reverse rotation condition value CV_{rb} to be a condition under which, in the metering process, the screw 28 is made to rotate in reverse more slowly than the screw 28 rotates in the forward direction. Consequently, during the reverse rotation of the screw 28, the influence of inertia and viscous resistance of the resin on the screw 28 becomes small. As a result, an excessive amount of reverse rotation of the screw 28 is suppressed.

The sucking back of the screw 28 and the reverse rotation of the screw 28 may be executed in an overlapping manner (i.e., concurrently or in parallel). Consequently, the expansion of the volume of the metering region due to sucking back of the screw 28, and the reverse flowing of the resin due to the reverse rotation of the screw 28 are caused to take place at the same time. As a result, the pressure P of the resin rapidly decreases. Further, by having the sucking back and the reverse rotation be executed in parallel, the cycle time can be made shorter. Moreover, in the case that the sucking back and the reverse rotation are performed in parallel, not only the resin but also the screw 28 moves in the rearward direction. In this case, the resin accumulated in the metering region is prevented from flowing out from the injection port 41.

The measurement unit 80 measures the reverse rotation state value SV_{rb}. The reverse rotation state value SV_{rb} indicates the reverse rotation state of the screw 28. The reverse rotation state value SV_{rb} is a rotational speed of the reversely-rotating screw 28, an amount of rotation of the reversely-rotating screw 28, or an elapsed time period as the screw rotates in reverse. In the case of the present embodiment, the rotational speed and the amount of rotation of the screw 28 as it rotates in reverse are measured on the basis of a detection signal from the position/speed sensor 60a. Further, the elapsed time period is measured, for example, by a timer function being realized by the computation unit 72.

The measurement unit 80 may measure at least two of the rotational speed of the screw 28 during reverse rotation thereof, the amount of rotation of the screw 28 during reverse rotation thereof, and the elapsed time period from the start of reverse rotation of the screw 28. In this instance, from among the reverse rotation state value SV_{rb}, the type of the value measured by the measurement unit 80, and from among the reverse rotation condition value CV_{rb}, the type of the value measured by the measurement unit 80 may be different from each other. For example, in the case that the target amount of reverse rotation R_{rb} is not included in the reverse rotation condition value CV_{rb}, the measurement unit 80 may measure the amount of rotation as the reverse rotation state value SV_{rb}.

After the start of reverse rotation, in the case that the reverse rotation state value SV_{rb} has reached the threshold value Th, the suck-back ending control unit 82 causes the sucking back of the screw 28 by the suck-back control unit 76 to end. In other words, the suck-back ending control unit 82 according to the present embodiment determines whether or not to cause the sucking back to end, based on a comparison between the reverse rotation state value SV_{rb} indicating the reverse rotation state of the screw 28 and the threshold value Th. In this case, it is unnecessary for the suck-back ending control unit 82 to monitor the pressure P of the resin.

In the case that the timing at which sucking back ends is determined based on the reverse rotation state value SV_{rb}, the timing at which sucking back ends is likely to be stabilized. The reason for this feature is as follows. The reverse rotation of the screw 28 is performed with good reproducibility due to the control of the motor being performed by the reverse rotation control unit 78 based on the reverse rotation condition value CV_{rb}. Therefore, the timing at which the reverse rotation state value SV_{rb} reaches the threshold value Th also has good reproducibility over the plurality of molding cycles. In this instance, the sucking back of the screw 28 comes to an end when the reverse rotation state value SV_{rb} reaches the threshold value Th. Consequently, the timing at which sucking back of the screw 28 ends has good reproducibility over the plurality of molding cycles.

Further, by intentionally determining the timing at which sucking back ends based on the reverse rotation state value SV_{rb}, an interrelation between the sucking back and the reverse rotation is improved.

The threshold value Th is stored (set) in the storage unit 70 corresponding to the reverse rotation state value SV_{rb} measured by the measurement unit 80. For example, in the case that the measurement unit 80 measures the rotational speed (reverse rotational speed) of the screw 28 as the reverse rotation state value SV_{rb}, a threshold value Th concerning the reverse rotational speed of the screw 28 is set. Further, for example, in the case that the measurement unit 80 measures the amount of rotation of the screw 28 during reverse rotation thereof as the reverse rotation state value SV_{rb}, a threshold value Th concerning the amount of reverse rotation is set. In the case that the measurement unit 80 measures the elapsed time period from the start of reverse rotation of the screw 28 as the reverse rotation state value SV_{rb}, a threshold value Th concerning such an elapsed time period is set.

It is preferable for the threshold value Th to be set in a manner so that the sucking back ends prior to the pressure P of the resin reaching the target pressure P₀. Consequently, after sucking back has ended, by performing only the reverse rotation from among the sucking back and the reverse rotation, the pressure P of the resin reaches the target pressure P₀. In this instance, by the screw 28 being rotated in reverse and not being moved rearward, the resin flows out from the metering region. As a result, the amount of the resin inside the metering region approaches the appropriate amount. The operator is capable of accurately adjusting the pressure P of the resin to the target pressure P₀, by setting the predetermined reverse rotation condition value CV_{rb} in consideration of the threshold value Th.

The pressure acquisition unit 84 serves to acquire the pressure P of the resin. The pressure acquisition unit 84 acquires the pressure P of the resin on the basis of the detection signal from the pressure sensor 30. The threshold value setting unit 86 sets a threshold value Th. Setting of the threshold value Th includes changing the set threshold value Th after having been set.

In the case that the pressure P of the resin has reached a predetermined suck-back ending pressure P₂, the threshold value setting unit 86 causes the storage unit 70 to store the reverse rotation state value SV_{rb} at the time of reaching thereof as the threshold value Th. Consequently, the threshold value Th is set in the control device 20. In this regard, in order that the threshold value setting unit 86 is caused to set the threshold value Th, exceptionally the suck-back ending control unit 82 may set as the suck-back ending condition the fact that the pressure P of the resin has reached the predetermined suck-back ending pressure P₂.

The predetermined suck-back ending pressure P₂ is predetermined to lie within a range (P₁>P₂≥P₀) that is less than the metering pressure P₁ and greater than or equal to the target pressure P₀. The predetermined suck-back ending pressure P₂ is stored in advance in the storage unit 70, and is referred to by the threshold value setting unit 86.

In the case that only the reverse rotation is performed after the sucking back and the reverse rotation have been executed in an overlapping manner, the predetermined suck-back ending pressure P₂ is preferably set to lie within a range of P₁>P₂>P₀. In accordance with this feature, the threshold value setting unit 86 can set the threshold value Th at which sucking back from among the sucking back and the reverse rotation is made to end first, prior to the pressure P of the resin reaching the target pressure P₀. Further, it is more preferable that the predetermined suck-back ending pressure P₂ is as close to the target pressure P₀ as possible. Consequently, the pressure P of the resin rapidly decreases to the target pressure P₀.

Moreover, in the case that the threshold value Th is set with respect to the reverse rotational speed of the screw 28, the predetermined suck-back ending pressure P₂ lies within a range that the pressure P of the resin is capable of reaching prior to the reverse rotational speed of the screw 28 reaching the target reverse rotational speed V_{rb}. By adjusting the suck-back speed V_{sb}, the operator is capable of keeping the predetermined suck-back ending pressure P₂ within the above range.

The display control unit 88 controls the display unit 66. For example, the display control unit 88 causes the display unit 66 to display the threshold value Th. The display control unit 88 preferably causes the display unit 66 to display the threshold value Th that is set by the threshold value setting unit 86. Consequently, the operator can be informed that the threshold value Th has been automatically set, together with the specific value of the threshold value Th.

The display control unit 88 may cause information other than the threshold value Th to be displayed on the display unit 66. For example, the display control unit 88 may cause the display unit 66 to display the reverse rotation condition value CV_{rb}, the reverse rotation state value SV_{rb}, the suck-back speed V_{sb}, and the pressure P of the resin.

It should be noted that the configuration of the control device 20 is not limited to the above description. For example, the control device 20 may further be equipped with a constituent element to control the injection unit 16 in the injection process. Further, the control device 20 may further be equipped with a constituent element to control the mold clamping unit 14. Moreover, the constituent element to control the injection unit 16 and the constituent element to control the mold clamping unit 14 may be realized on the basis of known techniques. The description of the control device 20 is as stated above.

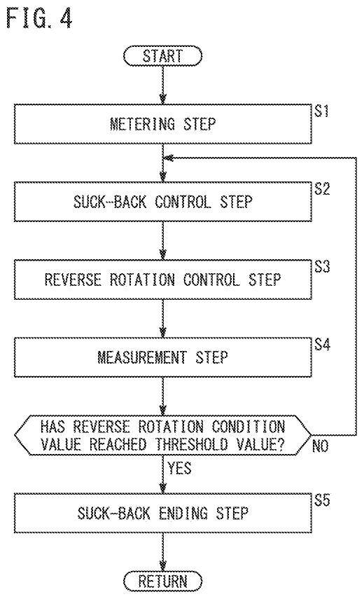

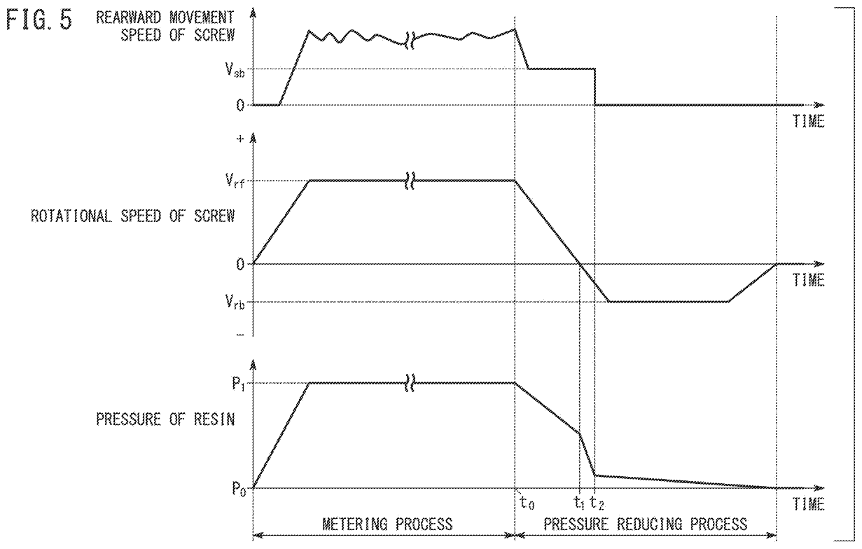

FIG. 4 is a first flowchart illustrating a process flow of the control method according to the embodiment. FIG. 5 is a first time chart illustrating a timewise transition of the rearward movement speed of the screw 28, the rotational speed of the screw 28, and the pressure P of the resin in the case that the control method shown in FIG. 4 is executed.

Hereinafter, a description of the control method of the present embodiment will be presented. The control method is executed by the control device 20. The control method of the present embodiment includes a metering step S1, a suck-back control step S2, a reverse rotation control step S3, a measurement step S4, and a suck-back ending step S5 (see FIG. 4). Moreover, in the example described below, the storage unit 70 has stored therein in advance the threshold value Th in relation to the continued time period of reverse rotation of the screw 28. The steps from the suck-back control step S2 to the suck-back ending step S5 are included in the pressure reducing process.

The metering step S1 is a step of executing a metering process. In the metering step S1, the metering control unit 75 performs metering of the resin by causing the screw 28 to move rearward while causing the screw 28 to undergo forward rotation. In accordance with this step, the resin accumulates in the metering region, together with the pressure P of the resin being adjusted to the predetermined measurement pressure P₁.

In the suck-back control step S2, after the screw 28 has reached the predetermined metering position, the suck-back control unit 76 causes the screw 28 to be sucked back at the predetermined suck-back speed V_{sb}.

Time t₀ in FIG. 5 indicates a point in time when the suck-back control step S2 is started. The point to is also a point in time when the metering process ends. Further, the point t₀ is also a point in time when the pressure reducing process starts. At the point to, the pressure P of the resin reaches the predetermined measurement pressure P₁. At point to, the suck-back control unit 76 causes the screw 28 to be sucked back. After point to, the suck-back control unit 76 adjusts the rearward movement speed of the screw 28 to the predetermined suck-back speed V_{sb} (refer to FIG. 5). Further, due to the sucking back being started, the pressure P of the resin begins to decrease from the predetermined measurement pressure P₁.

In the reverse rotation control step S3, at a time after sucking back of the screw 28 has started, the reverse rotation control unit 78 causes the screw 28 to be rotated in reverse based on the predetermined reverse rotation condition value CV_{rb}.

Time t₁ in FIG. 5 indicates a point in time when the reverse rotation control step S3 is started. More specifically, time t₁ indicates a point in time when the reverse rotation of the screw 28 is started. In the time chart in relation to the rotational speed of the screw 28 in FIG. 5, the “+” symbol indicates a forward direction of rotation of the screw 28. In the time chart in relation to the rotational speed of the screw 28 in FIG. 5, the “−” symbol indicates a reverse direction of rotation of the screw 28. During the time period from point t₀ to point t₁, the direction of rotation of the screw 28 is the forward direction of rotation. During the time period from point t₀ to point t₁, the rotational speed of the screw 28 gradually decelerates. Moreover, during the time period from point t₀ to point t₁, overrunning of the screw 28 may take place. When overrunning of the screw 28 takes place, an excessive amount of resin is delivered under pressure into the metering region. After point t₁, the screw 28 accelerates in the reverse direction of rotation at a predetermined acceleration based on the reverse rotation condition value CV_{rb}. Consequently, the rotational speed of the screw 28 reaches the target reverse rotational speed V_{rb}. Further, after point t₁, the screw 28 executes both sucking back and reverse rotation in an overlapping or concurrently. In accordance with this feature, after point t₁, the pressure P of the resin drops more rapidly than in the time period from point t₀ to point t₁.

In the measurement step S4, the measurement unit 80 measures the reverse rotation state value SV_{rb} that indicates the reverse rotation state of the screw 28 from the time that the reverse rotation was started.

The point in time when the measurement step S4 is started is the point t₁. That is, the measurement step S4 is started at the same time as the reverse rotation control step S3. The threshold value Th indicates the continued time period of the reverse rotation. Accordingly, the measurement unit 80 measures the continued time period of the reverse rotation as the reverse rotation state value SV_{rb}.

In the suck-back ending step S5, in the case that the reverse rotation state value SV_{rb} has reached the threshold value Th, the suck-back ending control unit 82 causes the sucking back of the screw 28 to end.

The point t₂ in FIG. 5 indicates a point in time at which the reverse rotation state value SV_{rb} reaches the threshold value Th. The screw 28 ends the sucking back at point t₂. However, the screw 28 continues being rotated in reverse after point t₂ and until the reverse rotation condition value CV_{rb} is satisfied. Accordingly, after point t₂, in accordance with the screw 28 being rotated in reverse, the pressure P of the resin decreases. Consequently, the pressure P of the resin reaches the target pressure P₀. Further, by the screw 28 being rotated in reverse without being sucked back, the resin in the metering region flows in reverse. In accordance with this feature, after point t₂, the amount of the resin in the metering region, which has become excessive due to the occurrence of overrunning during the metering process, approaches the appropriate amount.

An example of the process flow of the control method of the injection molding machine 10 by the control device 20 has been described above. Moreover, it should be noted that, although the example of FIG. 5 shows an example in which the reverse rotation is started after sucking back has been started, the sucking back and the reverse rotation may be started at the same time. In such a case, the sucking back of the screw 28 is made to wait until a point in time (point t₁ in FIG. 5) at which the rotational speed of the screw 28 changes to rotating in reverse. In accordance with this feature, the rearward movement speed of the screw 28 temporarily becomes zero after the metering process has ended (at point t₀ in FIG. 5). As a result, the screw 28 is capable of initiating the sucking back and the reverse rotation at the same time.

Next, a process flow of the control method in the case that the threshold value setting unit 86 sets the threshold value Th will be described.

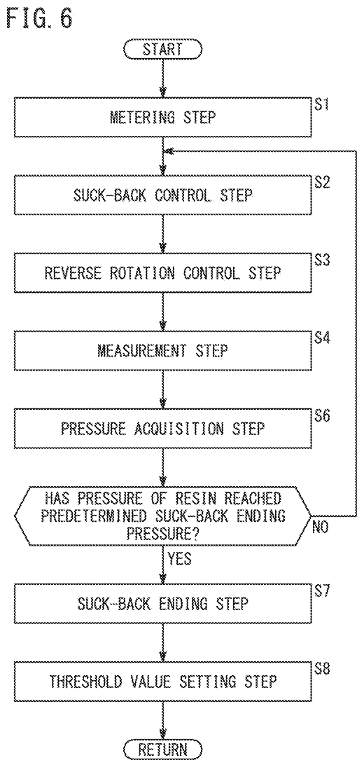

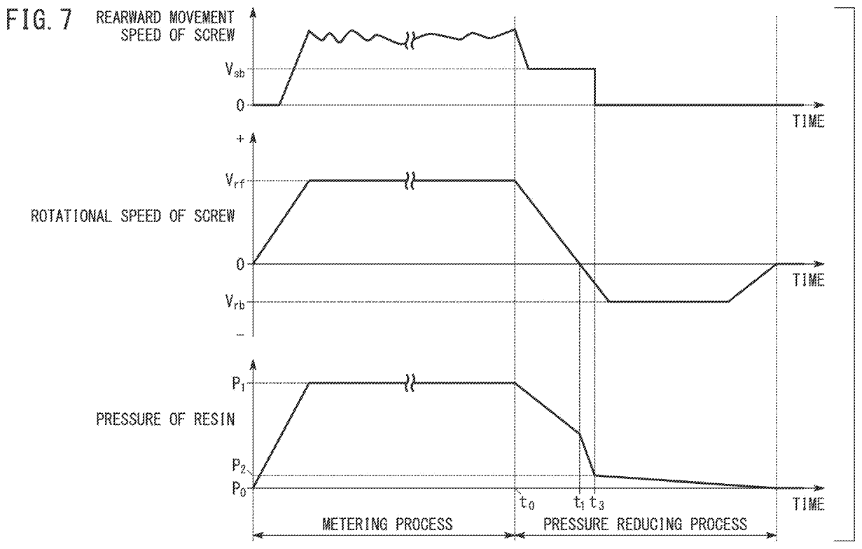

FIG. 6 is a second flowchart illustrating a process flow of the control method according to the embodiment. FIG. 7 is a second time chart illustrating a timewise transition of the rearward movement speed of the screw 28, the rotational speed of the screw 28, and the pressure P of the resin in the case that the control method shown in FIG. 6 is executed.

The control method shown in FIG. 6 includes a metering step S1, a suck-back control step S2, a reverse rotation control step S3, a measurement step S4, a pressure acquisition step S6, a suck-back ending step S7, and a threshold value setting step S8. The descriptions of the metering step S1, the suck-back control step S2, the reverse rotation control step S3, and the measurement step S4 overlap or are redundant with the steps having the same names and reference characters shown in FIG. 4, and therefore, hereinafter, descriptions of these steps will be appropriately omitted.

In the pressure acquisition step S6, the pressure acquisition unit 84 acquires the pressure P of the resin inside the cylinder 26. Acquisition of the pressure P of the resin is started together with the suck-back control step S2, and continues to be carried out until the suck-back ending step S7, which will be described later.

In the example shown in FIG. 7, the point in time when the pressure acquisition step S6 is started is the point t₀. The point to is a point in time when the pressure reducing process (the suck-back control step S2) is started. The point t₀ is also a point in time when the metering process ends. After point t₀, due to the sucking back being started, the pressure P of the resin begins to decrease from the predetermined metering pressure P₁. The pressure acquisition unit 84 continues to acquire the pressure P of the resin that is decreasing.

After point to, the reverse rotation control step S3 and the measurement step S4 are executed in the same manner as in the example shown in FIG. 5. In FIG. 7, the point t₁ is shown in the same manner as in FIG. 5. The point t₁ indicates the point in time when the reverse rotation control step S3 and the measurement step S4 are started.

In the suck-back ending step S7, in the case that the pressure P of the resin has reached the predetermined suck-back ending pressure P₂, the suck-back ending control unit 82 causes the sucking back to end. That is, the suck-back ending control unit 82 determines the timing at which sucking back ends, based on a comparison between the pressure P of the resin and the predetermined suck-back ending pressure P₂.

The point t₃ in FIG. 7 indicates a point in time at which the pressure P of the resin reaches the predetermined suck-back ending pressure P₂. The sucking back ends at point t₃. Even after point t₃, the reverse rotation of the screw 28 continues until the reverse rotation condition value CV_{rb} is satisfied. Accordingly, after point t₃, in accordance with the screw 28 being rotated in reverse, the pressure P of the resin reaches the target pressure P₀.

In the threshold value setting step S8, the threshold value setting unit 86 sets the threshold value Th on the basis of the reverse rotation state value SV_{rb} at the point in time (point t₃) when the pressure P of the resin during suck-back reaches the predetermined suck-back ending pressure P₂. The threshold value setting unit 86 sets as the threshold value Th into the control device 20, for example, the continued time period of reverse rotation that was measured in the measurement step S4. In accordance with this feature, the threshold value Th in relation to the continued time period of reverse rotation is set. In the next and subsequent molding cycles, the control device 20 executes the control method shown in FIG. 4 based on the threshold value Th that was set in the threshold value setting step S8. In that case, the point t₃ shown in FIG. 7 indicates the point t₂ in FIG. 5 (point t₃ in FIG. 7=point t₂ in FIG. 5).

The description of the control method for the injection molding machine 10 in the case that the threshold value setting unit 86 sets the threshold value Th is as stated above. The control method illustrated in FIG. 4 is executed in the case that the threshold value Th has already been set in the control device 20. By executing the control method shown in FIG. 4, the control device 20 satisfactorily reduces variations in the timing at which sucking back ends. On the other hand, in the case that the threshold value Th is not set, the control device 20 executes the control method shown in FIG. 6. Specifically, the control device 20 executes the control method shown in FIG. 6, for example, at a stage during a trial operation of the injection molding machine 10. However, even if the threshold value Th is set, the control device 20 may execute the control method shown in FIG. 6, for example, in the case that the operator desires for the threshold value Th to be reset. The control device 20 may receive, for example via the operation unit 68, an instruction to execute either one of the control method shown in FIG. 4 or the control method shown in FIG. 6. Further, the display control unit 88 may appropriately display information on the display unit 66 (perform a displaying step) in parallel with each of the steps illustrated respectively in FIG. 4 and FIG. 6.

As noted previously, according to the control device 20 and the control method of the present embodiment, in relation to the control of the injection molding machine 10, variations in the timing at which sucking back ends are reduced. Consequently, variations in operations in each of the molding cycles are reduced, and the cycle time for manufacturing molded products is stabilized. Further, the screw 28 of the present embodiment executes both sucking back and reverse rotation in an overlapping or in parallel with each other. Consequently, the pressure P of the resin rapidly decreases. As a result, the time required for the pressure reducing process is shortened, and production efficiency is improved. Furthermore, the screw 28 according to the present embodiment continues to rotate in reverse even after sucking back has ended. Consequently, the amount of the resin that has accumulated excessively in the metering region approaches the appropriate amount. As a result, any concerns over variations in the weight (or shape) of the molded product are reduced.

### [Modifications]

The embodiment has been described above as one example of the present invention. Various modifications or improvements can be added to the above-described embodiment. Further, it is clear from the description of the scope of the claims that other modes to which such modifications or improvements have been added can be included within the technical scope of the present invention.

Hereinafter, exemplary modifications according to the embodiment will be described. However, explanations that overlap with those of the embodiment will be omitted insofar as possible. Unless otherwise specified, reference numerals for constituent elements that have already been described in the context of the embodiment are used from the embodiment.

### (Exemplary Modification 1)

The threshold value setting unit 86 may set as the threshold value Th a minimum value, a maximum value, an average value, a median value, or a mode value of the reverse rotation state value SV_{rb} obtained through a predetermined number of times of measurements during a period in which the injection molding machine 10 executes the molding cycle for the predetermined number of times. For example, by executing the molding cycle a plurality of times, a plurality of the reverse rotation state values SV_{rb} are acquired. The threshold value setting unit 86 may set an average value of the plurality of reverse rotation state values SV_{rb} as the threshold value Th. Further, the plurality of the reverse rotation state values SV_{rb} may include a value (an outlier value) that significantly deviates from the average value of the plurality of the reverse rotation state values SV_{rb}. Such an outlier value is determined, for example, based on whether the value deviates from a predetermined range taking as a reference the average value. In this case, the threshold value setting unit 86 may set a median value or a mode value of the plurality of reverse rotation state values SV_{rb} as the threshold value Th. The median value and the mode value are less likely to be influenced by outlier values than the average value. Further, the control device 20 may cause there to be displayed on the display unit 66 a state of scattering of the reverse rotation state values SV_{rb}. In accordance with this feature, the operator is capable of visually confirming the state of scattering of the reverse rotation state values SV_{rb}. Further, the operator can select the type of the threshold value Th while taking into consideration the state of scattering of the reverse rotation state values SV_{rb}.

According to the present exemplary modification, the threshold value Th is less likely to receive an adverse influence from noise components included within the reverse rotation state value SV_{rb} that is measured, for example, in a certain molding cycle. Therefore, according to the present exemplary modification, it is possible to more reliably set a satisfactory threshold value Th.

### (Exemplary Modification 2)

The method of setting the threshold value Th is not limited to the method described in the embodiment or in the Exemplary Modification 1.

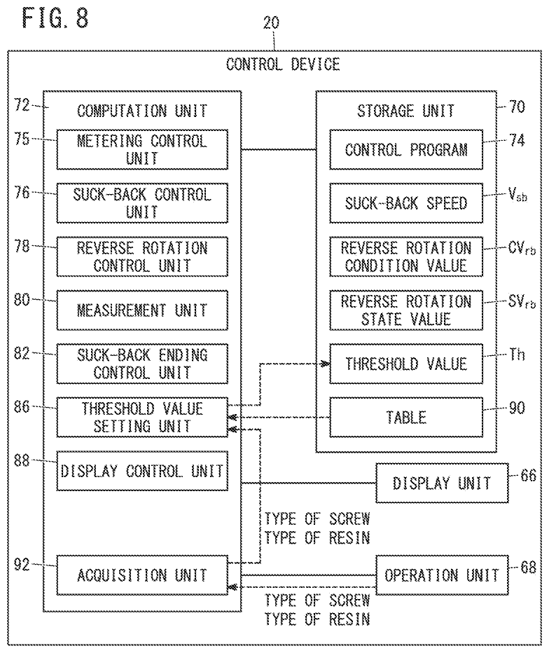

FIG. 8 is a schematic configuration diagram of the control device 20 according to an Exemplary Modification 2.

The control device 20 according to the present exemplary modification differs from the control device 20 of the embodiment (refer to FIG. 3) in relation to the following points (refer also to FIG. 8). The storage unit 70 according to the present exemplary modification stores a table 90. Further, the computation unit 72 according to the present exemplary modification is equipped with an acquisition unit 92. The computation unit 72 according to the present exemplary modification does not comprise the pressure acquisition unit 84.

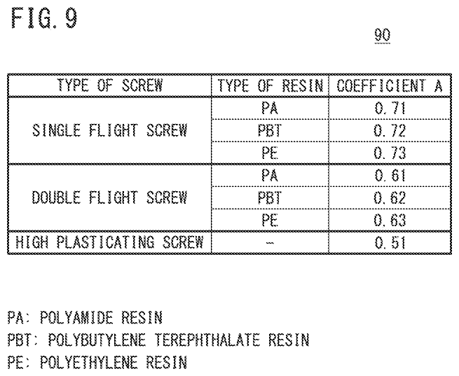

FIG. 9 is an exemplary configuration of the table 90 that is stored in the storage unit 70 according to the Exemplary Modification 2.

The table 90 shows a corresponding relationship between at least one of the type of the screw 28 or the type of the resin, and a coefficient A. For example, the table 90 in FIG. 9 shows the coefficient A as being “0.71” corresponding to a combination of the type of the screw 28 being a “single flight screw” and the type of the resin being a “PA (polyamide resin)”. Further, the table 90 in FIG. 9 shows the coefficient A as being “0.51” corresponding to the type of the screw 28 being a “high plasticating screw”.

Moreover, although not illustrated in FIG. 9, the table 90 may include a coefficient A corresponding to a “single flight screw” or a “double flight screw” without corresponding to the type of the resin. Alternatively, the table 90 may include a coefficient A corresponding to the type of the resin without corresponding to the type of the screw 28. Furthermore, the table 90 may include types of the screw 28 or types of the resin that are not illustrated in FIG. 9.

The acquisition unit 92 acquires the type of the screw 28, and the type of the resin that are used for injection molding. The acquisition unit 92, for example, acquires the type of the screw 28 and the type of the resin that are input by the operator via the operation unit 68.

The threshold value setting unit 86 according to the present exemplary modification acquires the coefficient A by referring to the table 90 based on the type of the screw 28 and the type of the resin acquired by the acquisition unit 92. Further, the threshold value setting unit 86 according to the present exemplary modification sets the product of the coefficient A and the predetermined reverse rotation condition value CV_{rb} as the threshold value Th. For example, the acquired type of the screw 28 was a “double flight screw”. Further, the acquired type of the resin was a “PBT (polybutylene terephthalate) resin”. In this case, the coefficient A is “0.62” (refer to FIG. 9). Accordingly, the threshold value setting unit 86 sets the product of the reverse rotation condition value CV_{rb} (for example, the continued time period of reverse rotation T r b) and “0.62” as the threshold value Th. The value of the calculated threshold value Th becomes greater as the coefficient A becomes greater. Accordingly, the larger the coefficient A, the longer the time period during which sucking back is executed becomes, and the smaller the coefficient A, the shorter the time period during which sucking back is executed becomes.

The range of the coefficient A is 0<A≤1, and more preferably, is 0<A<1. In the case that the threshold value Th is calculated based on the coefficient lying within the range of 0<A<1, the suck-back ending control unit 82 can cause the sucking back to end prior to the end of the reverse rotation. In other words, by the suck-back ending control unit 82 performing the reverse rotation after the overlapping execution of the sucking back and the reverse rotation, a time zone for adjusting the amount of the resin in the metering region can be ensured.

The reason as to why it is preferable to determine the coefficient A for each type of the screw 28 is because the ability of the screw to bring about back flowing of the resin differs depending on the type of the screw 28. For example, the ability of a single flight screw to bring about back flowing of the resin is relatively low in comparison with a double flight screw or a high plasticating screw. In this case, the coefficient A associated with a single flight screw is preferably greater than the coefficient A associated with the double flight screw or the high plasticating screw.

Consequently, in the case that the type of the screw 28 is a single flight screw, the time period during which sucking back is executed becomes longer. That is, the pressure P of the resin can be made to decrease as rapidly as possible.

The reason why it is preferable to determine the coefficient A for each type of resin is because the ease with which reverse rotation causes back flowing differs depending on the type of the resin. For example, a highly viscous resin is less likely to cause flowing back to occur. In other words, the pressure P of a highly viscous resin is less likely to decrease in accordance with the screw 28 being rotated in reverse. Accordingly, it is preferable to associate a highly viscous resin with a correspondingly larger coefficient A. In accordance with this feature, the time period during which sucking back is executed becomes longer. As a result, even in the case that a resin with high viscosity is used for injection molding, the pressure P of the resin can be quickly reduced.

According to the present exemplary modification, if the operator him/herself designates via the operation unit 68 the type of the screw 28 and the type of the resin of the injection molding machine 10 to be used, the threshold value setting unit 86 is capable of setting the threshold value Th. However, in the present exemplary modification, the coefficient A, which is multiplied by the reverse rotation condition value CV_{rb} to derive the threshold value Th, must be obtained in advance in accordance with the type of the screw 28 and the type of the resin. In this regard, for example, it is preferable for the manufacturer of the injection molding machine 10 to provide the operator with a table 90 that is experimentally constructed. In accordance with this feature, the burden on the operator in constructing the table 90 is reduced.

Moreover, the storage unit 70 may store a plurality of the tables 90. For example, the storage unit 70 may store a table 90 indicating the coefficient A in relation to the target reverse rotational speed V_{rb}, a table 90 indicating the coefficient A in relation to the continued time period of reverse rotation T r b, and a table 90 indicating the coefficient A in relation to the target amount of reverse rotation R_{rb}. Further, in the case that the coefficient A is capable of being specified based on only one from among the type of the screw 28 and the type of the resin, then the acquisition unit 92 need not be required to acquire the other remaining one.

### (Exemplary Modification 3)

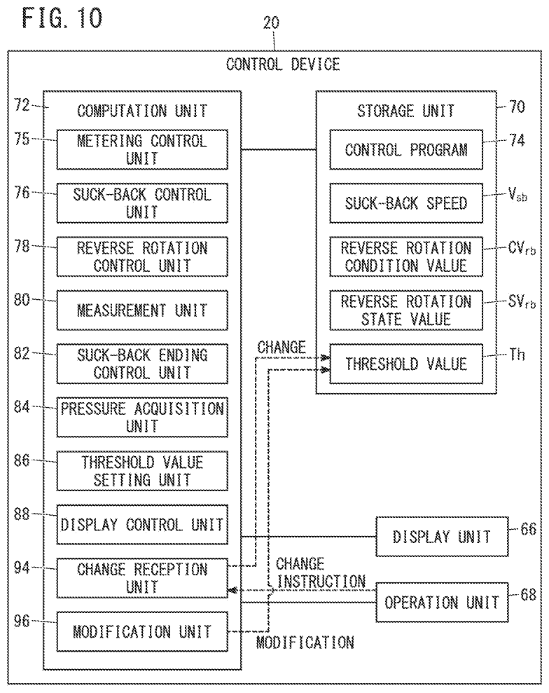

FIG. 10 is a schematic configuration diagram of the control device 20 according to an Exemplary Modification 3.

The control device 20 may further be equipped with a change reception unit 94 and a modification unit 96 (see FIG. 10). The change reception unit 94 receives an instruction (a change instruction) from the operator in order to change the threshold value Th that was set by the threshold value setting unit 86. The change instruction is input to the change reception unit 94, for example, via the operation unit 68.

The threshold value setting unit 86 automatically sets the threshold value Th (refer to the embodiment). However, there may be a case in which the operator wants to adjust the threshold value Th that was set by the threshold value setting unit 86 to a value investigated by the operator him/herself. According to the change reception unit 94, such a convenience for the operator can be provided.

In the case that the threshold value Th deviates from a predetermined range, the modification unit 96 modifies the threshold value Th in a manner so that the threshold value Th lies within the range. The range for the threshold value Th is obtained in advance, for example, on the basis of experiments conducted by the manufacturer of the injection molding machine 10. The range for the threshold value Th is stored in the storage unit 70. The modification unit 96 prevents the threshold value Th from being set to a value that is not expected by the manufacturer. The modification unit 96 may modify not only the threshold value Th that was changed by the operator, but also the threshold value Th that was automatically set by the threshold value setting unit 86.

### (Exemplary Modification 4)

In the case that the reverse rotation of the screw 28 has ended prior to the ending of the sucking back of the screw 28, the suck-back ending control unit 82 may forcibly cause the sucking back of the screw 28 to end. For example, in the case that the threshold value Th is set so large that the sucking back continues even after the reverse rotation of the screw 28 has ended, the suck-back ending control unit 82 may forcibly cause the sucking back to end at the timing at which the reverse rotation of the screw 28 has ended. In accordance with this feature, the suck-back ending control unit 82 is capable of suppressing, to a minimum, sucking back operations that are not intended by the manufacturer of the injection molding machine

### (Exemplary Modification 5)

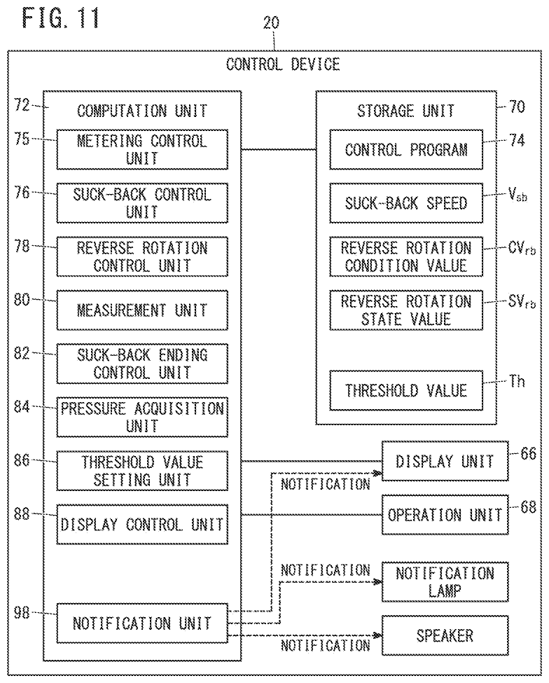

FIG. 11 is a schematic configuration diagram of the control device 20 according to an Exemplary Modification 5.

The control device 20 may further be equipped with a notification unit 98 (refer to FIG. 11). The notification unit 98 issues a notification that the reverse rotation has ended prior to the sucking back of the screw 28 ending, in the case that the reverse rotation has ended prior to the sucking back of the screw 28 ending. Consequently, the operator is made capable of recognizing that the sucking back did not end normally.

The notification unit 98 issues such a notification to the operator, for example, by causing there to be displayed on the display unit 66 a message indicating that the reverse rotation has ended prior to the sucking back ending. However, the present exemplary modification is not limited to this feature. For example, the notification unit 98 may cause a notification lamp (lamp) provided in the injection molding machine 10 to be illuminated. Further, the notification unit 98 may emit a sound from a speaker provided in the injection molding machine 10.

### (Exemplary Modification 6)

The injection molding machine 10 to which the control device 20 is applied is not limited to being an inline injection molding machine. The injection molding machine 10 may be, for example, a preplasticating type of injection molding machine.

### (Exemplary Modification 7)

The above-described embodiments and the respective modifications thereof may be appropriately combined within a range in which no technical inconsistencies occur.

[Inventions that can be Obtained from the Embodiment]

The inventions that can be grasped from the above-described embodiment and the modifications thereof will be described below.

### <First Invention>

The control device (20) is used for the injection molding machine (10), the injection molding machine including the cylinder (26) and the screw (28) configured to rotate and move forward and rearward within the cylinder. The control device performs the metering of the resin inside the cylinder (26) by moving the screw rearward to the predetermined metering position while the screw is being forwardly rotated. The control device includes: the suck-back control unit (76) that sucks back the screw at the predetermined suck-back speed (V sb) after the screw has reached the predetermined metering position, the reverse rotation control unit (78) that performs reverse rotation of the screw based on the predetermined reverse rotation condition value (CV_{rb}) after sucking back of the screw has started, the measurement unit (80) that measures the reverse rotation state value (SV_{rb}) indicating the reverse rotation state of the screw from a time when the reverse rotation of the screw has been started, and the suck-back ending control unit (82) that causes the sucking back of the screw by the suck-back control unit to end, at a time when the reverse rotation state value has reached the threshold value (Th).

In accordance with such features, the control device is provided that causes the variation in the timing at which the sucking back ends to be reduced.

The first invention may further include the threshold value setting unit (86) that sets the threshold value, and the table (90) that stores therein the coefficient (A) corresponding to at least one of the type of the screw or the type of the resin, and the acquisition unit (92) that acquires the type of at least one of the screw or the resin used in the injection molding, wherein the threshold value setting unit may set as the threshold value a value obtained by multiplying, by the predetermined reverse rotation condition value, the coefficient corresponding to the type of at least one of the screw or the resin acquired by the acquisition unit. In accordance with such features, for example, the threshold value can be easily set.

The first invention may further include the threshold value setting unit (86) that sets the threshold value, and the pressure acquisition unit (84) that acquires the pressure (P) of the resin inside the cylinder, wherein, in the case that the threshold value is set by the threshold value setting unit, the suck-back ending control unit may not end the sucking back of the screw by the suck-back control unit (76) until the pressure (P) of the resin reaches the predetermined suck-back ending pressure (P₂), and the threshold value setting unit may set the threshold value based on the reverse rotation state value (SV_{rb}) at a time when the pressure (P) of the resin during the sucking back has reached the predetermined suck-back ending pressure (P₂). In accordance with such features, for example, the threshold value can be satisfactorily set.

The threshold value setting unit may calculate as the threshold value a minimum value, a maximum value, an average value, a median value, or a mode value of the reverse rotation state value (SV_{rb}) obtained through a predetermined number of times of measurements during a period in which the injection molding machine executes the molding cycle for the predetermined number of times. In accordance with this feature, for example, the threshold value can be more satisfactorily set.

The first invention may further include the change reception unit (94) that receives a change instruction from the operator to change the threshold value set by the threshold value setting unit. In accordance with this feature, it is possible to enhance the convenience of the operator who wishes to change the threshold value set by the threshold value setting unit to a value investigated by the operator him/herself.

The first invention may further include the modification unit (96) which, in the case that the threshold value deviates from the predetermined range, modifies the threshold value so as to lie within the range. In accordance with this feature, even in the case that an abnormal value is set as the threshold value, it is possible to prevent the injection molding from being executed based on the abnormal value.

The first invention may further include the display control unit (88) that displays the threshold value on the display unit (66). In accordance with this feature, it is possible to notify the operator that the threshold value has been set, along with the specific value of the threshold value.

In the case that the reverse rotation has ended prior to ending of the sucking back of the screw, the suck-back ending control unit may forcibly cause the sucking back of the screw to end. In accordance with this feature, even if the injection molding machine performs a sucking back operation contrary to the intentions of the operator, such an operation can be kept to a minimum.

The first invention may further include the notification unit (98) which, in the case that the reverse rotation has ended prior to ending of the sucking back of the screw, issues a notification that the reverse rotation has ended prior to ending of the sucking back of the screw. In accordance with this feature, it is possible for the operator to recognize that the sucking back did not end normally.

The predetermined reverse rotation condition value may include at least two from among a continued time period of the reverse rotation (T_{rb}), a target reverse rotational speed (V_{rb}), and a target amount of reverse rotation (R_{rb}) to cause the reverse rotation to end.

The reverse rotation state value may be a rotational speed of the screw that is reversely rotating, or an amount of rotation or an elapsed time period from when the reverse rotation of the screw is started.

### <Second Invention>

The control method is used in the injection molding machine (10), the injection molding machine including the cylinder (26) and the screw (28) configured to rotate and move forward and rearward within the cylinder. The control method performs the metering of the resin inside the cylinder (26) by moving the screw rearward to the predetermined metering position while the screw is being forwardly rotated. The control method includes: the suck-back control step (S2) of sucking back the screw at the predetermined suck-back speed (V sb) after the screw has reached the predetermined metering position, the reverse rotation control step (S3) of performing reverse rotation of the screw based on the predetermined reverse rotation condition value (CV_{rb}) after sucking back of the screw has started, the measurement step (S4) of measuring the reverse rotation state value (SV_{rb}) indicating the reverse rotation state of the screw from a time when the reverse rotation of the screw has been started, and the suck-back ending step (S5) of causing the sucking back of the screw by the suck-back control step to end, at a time when the reverse rotation state value has reached the threshold value (Th).

In accordance with such features, the control method is provided that causes the variation in the timing at which the sucking back ends, to be reduced.

The second invention may further include the threshold value setting step (S8) of setting the threshold value, and the acquisition step of acquiring a type of at least one of the screw or the resin used in the injection molding, wherein, in the threshold value setting step, based on the table (90) in which there is stored the coefficient (A) corresponding to at least one of the type of the screw or the type of the resin, the value obtained by multiplying, by the predetermined reverse rotation condition value, the coefficient (A) corresponding to the type of at least one of the screw or the resin acquired in the acquisition step may be set as the threshold value. In accordance with such features, for example, the threshold value can be easily set.

The second invention may further include the threshold value setting step (S8) of setting the threshold value, and the pressure acquisition step (S6) of acquiring the pressure (P) of the resin inside the cylinder, wherein, in the suck-back ending step, in the case that the threshold value setting step (S8) is carried out, the sucking back of the screw by the suck-back control step may not be ended until the pressure (P) of the resin reaches the predetermined suck-back ending pressure (P₂), and in the threshold value setting step, the threshold value may be set based on the reverse rotation state value (SV_{rb}) at a time when the pressure (P) of the resin during the sucking back has reached the predetermined suck-back ending pressure (P₂). In accordance with such features, for example, the threshold value can be satisfactorily set.

1. A control device for an injection molding machine, the injection molding machine comprising a cylinder and a screw configured to rotate and move forward and rearward within the cylinder, the control device being configured to perform a metering of resin inside the cylinder by moving the screw rearward to a predetermined metering position while the screw is being forwardly rotated, the control device comprising:
a suck-back control unit configured to suck back the screw at a predetermined suck-back speed after the screw has reached the predetermined metering position;
a reverse rotation control unit configured to perform reverse rotation of the screw based on a predetermined reverse rotation condition value after sucking back of the screw has started;
a measurement unit configured to measure a reverse rotation state value indicating a reverse rotation state of the screw from a time when the reverse rotation of the screw has been started; and
a suck-back ending control unit configured to cause the sucking back of the screw by the suck-back control unit to end, at a time when the reverse rotation state value has reached a threshold value.

2. The control device according to claim 1, further comprising:
a threshold value setting unit configured to set the threshold value;
a table that stores therein a coefficient corresponding to at least one of a type of the screw or a type of the resin; and
an acquisition unit configured to acquire the type of at least one of the screw or the resin used in an injection molding;
wherein the threshold value setting unit sets as the threshold value a value obtained by multiplying, by the predetermined reverse rotation condition value, the coefficient corresponding to the type of at least one of the screw or the resin acquired by the acquisition unit.

3. The control device according to claim 1, further comprising:
a threshold value setting unit configured to set the threshold value; and
a pressure acquisition unit configured to acquire a pressure of the resin inside the cylinder;
wherein, in a case that the threshold value is set by the threshold value setting unit, the suck-back ending control unit does not end the sucking back of the screw by the suck-back control unit until the pressure of the resin reaches a predetermined suck-back ending pressure; and
the threshold value setting unit sets the threshold value based on the reverse rotation state value at a time when the pressure of the resin during the sucking back has reached the predetermined suck-back ending pressure.

4. The control device according to claim 3, wherein the threshold value setting unit calculates as the threshold value a minimum value, a maximum value, an average value, a median value, or a mode value of the reverse rotation state value obtained through a predetermined number of times of measurements during a period in which the injection molding machine executes a molding cycle for the predetermined number of times.

5. The control device according to claim 2, further comprising a change reception unit configured to receive a change instruction from an operator to change the threshold value set by the threshold value setting unit.

6. The control device according to claim 1, further comprising a modification unit configured to, in a case that the threshold value deviates from a predetermined range, modify the threshold value so as to lie within the range.

7. The control device according to claim 1, further comprising a display control unit configured to display the threshold value on a display unit.

8. The control device according to claim 1, wherein, in a case that the reverse rotation has ended prior to ending of the sucking back of the screw, the suck-back ending control unit forcibly causes the sucking back of the screw to end.

9. The control device according to claim 1, further comprising a notification unit configured to, in a case that the reverse rotation has ended prior to ending of the sucking back of the screw, issue a notification that the reverse rotation has ended prior to ending of the sucking back of the screw.

10. The control device according to claim 1, wherein the predetermined reverse rotation condition value includes at least two from among a continued time period of the reverse rotation a target reverse rotational speed, and a target amount of reverse rotation to cause the reverse rotation to end.

11. The control device according to claim 1, wherein the reverse rotation state value is a rotational speed of the screw that is reversely rotating, or an amount of rotation or an elapsed time period from when the reverse rotation of the screw is started.

12. A control method for an injection molding machine, the injection molding machine comprising a cylinder and a screw configured to rotate and move forward and rearward within the cylinder, the control method for performing a metering of resin inside the cylinder by moving the screw rearward to a predetermined metering position while the screw is being forwardly rotated, the control method comprising:
a suck-back control step of sucking back the screw at a predetermined suck-back speed after the screw has reached the predetermined metering position;
a reverse rotation control step of performing reverse rotation of the screw based on a predetermined reverse rotation condition value after sucking back of the screw has started;
a measurement step of measuring a reverse rotation state value indicating a reverse rotation state of the screw from a time when the reverse rotation of the screw has been started; and
a suck-back ending step of causing the sucking back of the screw by the suck-back control step to end, at a time when the reverse rotation state value has reached a threshold value.

13. The control method according to claim 12, further comprising:
a threshold value setting step of setting the threshold value; and
an acquisition step of acquiring a type of at least one of the screw or the resin used in an injection molding,
wherein, in the threshold value setting step, based on a table in which there is stored a coefficient corresponding to at least one of the type of the screw or the type of the resin, a value obtained by multiplying, by the predetermined reverse rotation condition value, the coefficient corresponding to the type of at least one of the screw or the resin acquired in the acquisition step is set as the threshold value.

14. The control method according to claim 12, further comprising:
a threshold value setting step of setting the threshold value; and
a pressure acquisition step of acquiring a pressure of the resin inside the cylinder;
wherein, in the suck-back ending step, in a case that the threshold value setting step is carried out, the sucking back of the screw by the suck-back control step is not ended until the pressure of the resin reaches a predetermined suck-back ending pressure; and
in the threshold value setting step, the threshold value is set based on the reverse rotation state value at a time when the pressure of the resin during the sucking back has reached the predetermined suck-back ending pressure.
